(19) United States
(12) Patent Application Publication
(10) Pub. No.: US 2002/0097371 A1
(43) Pub. Date: Jul. 25, 2002

(54) Position sensing device

(76) Inventor: Katsumi Yoshino, Kishiwada-shi (JP)

Correspondence Address: MERCHANT & GOULD PC, P.O. BOX 2903, MINNEAPOLIS, MN, 55402-0903, US

(21) Appl. No.: 10/034,987

(22) Filed: Dec. 26, 2001

(30) Foreign Application Priority Data
Dec. 22, 2000 (JP) 2000-389916

(51) Int. Cl. G02F 1/13

(52) U.S. Cl. 349/199

(57) ABSTRACT

The invention provides a position sensing device making use of electro-optic effects of a liquid crystal in which a liquid crystal display panel 1 is composed of a pair of glass substrates 2 opposed to each other at an interval with a spacer 3 interposed therebetween, and liquid crystal 4 enclosed between the glass substrates, and the glass substrates 2 each has an ITO membrane 5 deposited thereon to form liquid crystal drive electrodes to which a voltage controlled by a control circuit is applied and the height of waveform and width of a signal which changes the voltage is changed.

### INCORPORATION BY REFERENCE

The present application incorporates by reference Japanese application 2000-389916, filed Dec. 22, 2000.

### BACKGROUND OF THE INVENTION

The invention relates to a precise position sensing device for a type of drive system actuator, for example such as that used for biotechnology inspection equipments. The invention may be applied, for example, to numerical-control work, a machine, conveyance and placement equipment for a semiconductor board, 3-dimensional drawing equipment, the equipment for an endoscopic operation, micro-machine manufacturing equipment, a multi-joint robot, gene-therapy medicine manufacturing equipment, form measurement equipment for position control, inspection equipment for an optical disc, DNA inspection equipment, DNA analysis equipment, and inspection equipment for detecting defective plastic products.

Recently, the demand for servo motors is increasing in the field of semiconductor or liquid crystal production equipment, as well as inserters, mounting machines or machine tools. Furthermore, the application of servo motors is expanding to injection molding machines or printing machines with improvements in accuracy. On the other hand, the development of small servo mechanisms for application to minute machining/inspection technology, such as micro factories or small robots also is pursued.

A highly precise servo generally includes a drive motor, a slowdown machine for slight movement, and a position detection machine. With respect to the position detection machine signal processing can become an issue, due to simple detection becoming complicated since a software burden is high. Therefore, further hardware development would be desirable. For example, by the increment detection method on the basis of the relative information from an encoder, specialization of an observation position is difficult and cannot suppress an error only by recognition by software. Thus, absolute value position detection on a nano scale and an observation position is important to the future of a position detection machine. Such a highly precise position detection machine would be useful, for example since compensation against tracking error of a high density optical disk drive can be performed, for example, automatic focal adjustment, temperature drift compensation, etc. Thus a very quick and precise drive would be avaialble. Moreover, the equipment able to detect defective portions on a nano order of sensitivity precisely would be desirable for example for crystalloid inspection of a high-density disk product, and for surface accuracy measurement equipment, such as evaluating sinuosity. Furthermore, it would be desirable for high-speed production, and surface crack detection use.

Generally, an optical system and a magnetic system change from a scale and a detection portion to the latest move position detection system respectively. The former is the system that detects optical characteristic change using Light Emitting Diode or LD, and the latter is a system which detects the magnetism from a magnetic body with a coil etc. Moreover, in order that both may realize high sensitivity, the system is used in which a sensor signal is made to produce a phase by arrangement of a multi-element detection machine, and carries out a doubling by the logic element conventionally, or quantifies a detection analog signal. While this is acceptable for some purposes, the method of this doubling is important and it depends for the cause of an error by soft processing on the quality in position detection to a nano order. The system in which that detection sensitivity is the highest is an optical doubling system, and is raising sensitivity by quantification of the analog signal from a pickup. In addition, in the case of a magnetic system, there is a change of magnetic density with the passage of time.

Moreover, generally the disturbing influence by the diffraction of light is raised for optical position detection, and if a pattern becomes fine, the point at which measurement accuracy deteriorates due to interference of transmitted light or reflected light will not be avoided. Moreover, since the linearity of the accuracy of multi-element arrangement is demanded in the doubling for raising sensitivity, and the position pair signal output characteristic from a pickup is lacking in error recognition and reproducibility, when quantifying, the heavy burden on software is left as an issue. It is necessary to take into consideration the environmental temperature, such as the effect on the scale, which is the element of a position detection machine, especially a temperature shock, in the material side. For example, although manufacture of a small precision scale is possible if micro-machining technology and vacuum evaporation technology are used in the process of a nano scale, since it is hard to give sufficient thickness, sufficient reliability cannot be acquired, which easily can be affected by small residual stress or heat stress, especially when driven at high speed. Therefore, the conventional optical detection suffers from limits in obtaining both high sensitivity and high reliability, and a new scale material would be desirable.

It would be desirable if the technology of detecting a position absolutely is again used together as mentioned above. Therefore, although the method of learning by stamping the pattern for knowing a position absolutely in a scale was taken when a precision vacuum evaporation scale was produced conventionally, it is complicated and production became difficult and expensive.

### SUMMARY OF THE INVENTION

This invention utilizes the following three points in order to solve the above-mentioned problems.

(1) It makes the lattice unit equivalent to the slit of an encoder to be longer than the wavelength of light as much as possible, and quantification of an analog signal raises sensitivity.

(2) It offers a device that can cover the large drive range from several 100 mm to a nano domain, having a material and thickness suitable to provide heat and wear resistance.

(3) It changes arbitrary patterns and pixels reversibly within a precise position sensing device, and makes absolute position detection easy.

The inventor found out that above-mentioned characteristics could be attained by using optical modulators, such as a liquid crystal display panel and an electroluminescence element, and completed this invention.

The invention provides a position sensing device which comprises an optical modulator comprising two or more pixels, a drive part which applying a voltage to the optical modulator, a light source such as a floodlight that irradiates light on the optical modulator, and a photodetector that detects the transmitted/scattered light of the light irradiated to the optical modulator, wherein the position sensing device has a control means to change a drive voltage applied to the drive part thereby controlling the height and/or the width of waveform of a signal.

The optical modulator of this invention specifically may comprise two or more pixels. The drive part impresses voltage to this optical modulator, and the light source irradiates light at the above-mentioned optical modulator. The precise position sensing device may include a detection device that carries out the photodetection of the transmitted light irradiated by the optical modulator and the scattered light, and is characterized by having a control means to change drive voltage to the above-mentioned drive part, and affecting 5 the height of a signal waveform by changing this drive voltage, or adjusting width. Here, as an optical modulator, although a liquid crystal display panel and electro-luminescence (EL) electronic display, coloring matter, etc. can be mentioned, for example, it is not limited to these. That is, optical modulators, such as a liquid crystal display panel, have strong composition elements which can apply the intended characteristic to specific arbitrary positions by application of an electric field, such as a specific point, and this invention can use the ability to control easily the distribution and color of a refractive index while accommodating temperature change.

Liquid crystal is enclosed between a pair of electrode-plate boards, and a liquid crystal panel is manufactured.

Each electrode-plate board may function as an electrode plate on a glass board, for example, the vacuum evaporation of the ITO film (InSnO₃) is carried out, and it is formed. Although liquid crystal devices can be constituted from a double refraction type liquid crystal element, a transmission/scattering type liquid crystal element, TN (twisted nematic) liquid crystal, STN (super TN) liquid crystal, a ferroelectric liquid crystal element, an anti-ferroelectric liquid crystal, or a polymer dispersed liquid crystal, it is not limited to these.

The cell gaps may be in the range of 1-100 micrometers, 5-20 micrometers preferably.

As for the size and form of a pixel of a liquid crystal display panel, desirable conditions are decided according to a use. For example, by the alternate pattern, the pixel may have 10-100 micrometer width and 10-100 micrometer pitch. Furthermore, binary codes, such as a binary code or a gray code, also can be displayed on a liquid crystal display panel. Here, a binary code means the scale constituted of a white pixel and a black pixel. As for a gray code, a coding pattern always means the code not changing only for one bit. After are being positioned close to an optical sensor and acquiring an electric signal, when moving the transmitted light or the reflected light from the minimum pattern, minute position information can be known by quantifying signal intensity.

Even if the drive voltage in a liquid crystal drive part impresses direct-current voltage, even if it impresses other exchange signals, it is not cared about. The cell gap used in the liquid crystal display panel preferably is 5-20 micrometers. Drive frequency is in the range of 10 Hz to 1 kHz, preferably 100-700 Hz. Amplitude voltage impressed the rectangle wave of 5-50V preferably 10-25V. Drive voltage is changed within the limits, or optimization becomes possible by adjusting pulse width. By regulation of drive voltage, adjustment of a liquid crystal refractive-index distribution can be performed, and the following effect produces it.

(1) Regulation of the Numerical Aperture of a lens can be performed. Application of voltage produces the lens action effect by arrangement of liquid crystal. Regulation of a focal function is attained by voltage adjustment. It is also possible to use surface unevenness for detecting with high precision.

(2) Detection capability improves. The amplitude of a signal becomes high and SN ratio goes up it so that applied voltage is high.

(3) Point detection is attained from the difference in amplitude. That is, the absolute position of move distance can be specified arbitrarily. In addition, although it is sufficient even if it changes two or more pixels as the drive voltage of liquid crystal changes when carrying out point detection, it is desirable to make it change independently for every pixel. Moreover, the control means used for this invention need not be limited and can be a generally known computer that controls for example, a liquid crystal drive driver.

As a light source, although a light emitting diode, laser, a lamp, EL (electroluminescence), etc. can be mentioned, for example, it is not limited to these. The wavelength region to use is an ultraviolet ray—infrared domain. The 300-1500 nm wavelength region can be used preferably. Moreover, a point light source or a flat light is sufficient as a light source.

Various optical sensors, such as a photo-diode, a photomultiplier, a solid photodetection sensor, a pyroelectric sensor, and a thermopile, can be used for an optical detection machine. Moreover, a device that includes both the light source and the optical detection machine like a photo-coupler may be used. Furthermore, two or more light sources and optical detection machines may be installed like an array light source and position sensing device. Moreover, a light source may be a point light source or a field light source, and only the optical detection machine is possible, two or more cases or when that reverse.

A slit may be provided further for prevention of disturbance light among optical modulators, such as a light source and a liquid crystal panel, or between optical modulators, such as a liquid crystal panel, a photodetector's, and an optical detection machine. Although slit width differs according to the size of a liquid crystal pixel, in the case of a scale, it generally is 50-500 micrometers, for example. Moreover, in this invention, a means to make an optical system scan along a liquid crystal display panel side may be present. This may include a system in a mirror is provided between an optical detection machine and an optical modulator, a scanning device and a light source are installed in a stand for light by scanning of the mirror for example, and a stand is moved as a scanning means of a light source, it is not limited to these. When moving a stand, it may be made to move by the linear motor, the ball screw transport mechanism, etc. Moreover, a system can be used in which a condensing mirror is between an optical modulator and an optical detection machine, and scans a mirror. Moreover, the scanning direction may not be limited in the one direction of a liquid crystal panel, but any of the direction of X-Y and the direction of zigzag scan are sufficient.

This invention also provides the equipment having a move means to move a subject to the position memorized in the precise position sensing device mentioned above, the memory part which memorizes the position of the pixel of a precise position sensing device of operation, and this memory part. That is, a liquid crystal display panel etc. can move a subject to a target position. When memorizing the position, for example a power supply is switched on, since it was possible to have made arbitrary positions drive. Moreover, since a position can check correctly absolutely immediately after power is supplied, it leads to curtailment of the preparation time of production/inspection equipment, and curtailment of maintenance time. As a move means, although a motor, a cylinder, a spring, etc. can be mentioned, it is not limited to these, for example. Moreover, as a motor, although a servo motor can be used, for example, it is not limited to this.

### BRIEF DESCRIPTION OF DRAWING

FIG. 1 shows an embodiment of the position sensing device making use of opto-electronic effects of a liquid crystal display according to the invention;

FIG. 2 shows output characteristics at the time of pickup scan on a liquid crystal window; and

FIG. 3 shows the configuration of an absolute type servo.

### DESCRIPTION OF PREFERRED EMBODIMENTS

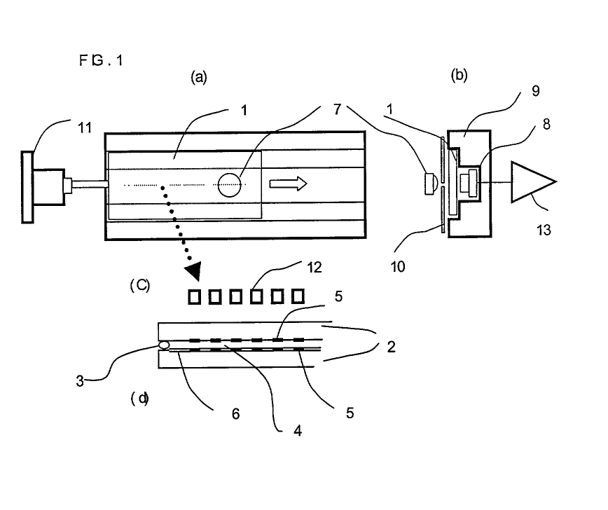

Embodiments of the invention are described with reference to drawings. FIG. 1a-d illustrates the liquid crystal precise position sensing device of this invention. 1 of FIG. 1 is a liquid crystal display panel, and the liquid crystal display panel 1 includes makes a pair of glass boards 2 and the spacer 3, held for example, at intervals of 5 micrometers, and enclosing liquid crystal 4. Moreover, the vacuum evaporation of the ITO film 5 is carried out on the glass board 2, the liquid crystal drive electrode plate is formed, and the voltage controlled by the control circuit, which may be a liquid crystal drive electrode plate (not illustrated). The pattern 12 which forms the optical transmission window of 30 micrometer by ITO film is created in 30 micrometer pitch at one side of the glass board 2 (FIG. 1(c)) and a 30 micrometer pattern of the same ITO film 5 is provided on the opposing the glass board 2, and the aluminum vacuum evaporation film 6 for shading short-circuits it at the circumference of the ITO film 5, and is formed in it. In addition, as liquid crystal 4, TN (twisted nematic) liquid crystal is used, for example.

The detection part, which includes light emitting diode 7 and a photo-diode (PD) 8 is installed in the both sides of the liquid crystal display panel 1. The detection part may accommodate PD 8 in the hollow of the alumina board 9 as shown in FIG. 1(b), and arranges the liquid crystal display panel 1 at a different level.

Between light emitting diode 7 and the liquid crystal display panel 1, the aperture 10, for example of 100 micrometers in diameter is formed, and the clearance is made to be set to 1 micrometer using the alumina board 9. The wavelength of light emitting diode 7 used as a light source sets drive frequency to 60 kHz by 860 nm. Photodetection is carried out using a light beam that passed the aperture 10 and the liquid crystal display panel 1 as Idei again from the liquid crystal display panel 1, by incidence on PD 8. In addition, the liquid crystal display panel 1 is connected to the motor 11, and after amplifying the direct-current signal it is moved along the level difference portion of the alumina board 9 at 1 mm/second uniform velocity. The signal is outputted from PD 8 through amplifier 13, and it is sent to the signal processing circuit (not illustrated).

Voltage was applied to each ITO pattern simultaneously, and the reproducibility of the light beam which was emitted from the liquid crystal precise position sensing device was evaluated. Evaluation with the same case where an electric field is not impressed to the case having a vacuum evaporation glass board and a liquid crystal panel was performed as a comparison. The pulse (12 of a reverse phase or 15V, and 500 Hz) was mutually impressed to the both ends of liquid crystal during measurement. The drive voltage of liquid crystal was changed and the dependability over a liquid crystal drive of the detected signal characteristic was investigated.

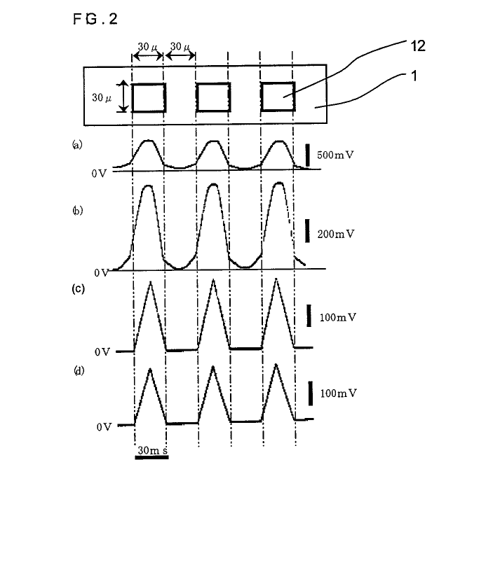

An experimental result is shown in FIG. 2. FIG. 2 is a figure showing the trace of a pickup signal, in which (a) does not impress an electric field to (b) liquid crystal panel only in the case of the glass board with a vacuum evaporation film, in electric-field 15V pulse application, (c) shows the output characteristic which obtained (d) in electric-field 12V pulse application. As (b) of FIG. 2 shows, usually, by the lattice board or the liquid crystal display panel, to the pickup appearance being distorted, the good move position pair signal intensity of the linearity according to the width and the interval of a window is obtained, and it turns out that it is a desirable analog detected signal at the time of a liquid crystal drive. This has suggested that it is shown that a position is detectable in high sensitivity, and very high sensitivity of about 3-4 figures can be realized by quantification. Moreover, the good result was obtained also in the reproducibility between the liquid crystal windows of a signal waveform. At that time, as shown in (c) of FIG. 2, and (d), by changing drive voltage showed that regulation of wave-like height and the ratio of width was easy. If the point that waveform form differs is used when impressing an electric field to a liquid crystal panel, and when that is not right, it is shown by making each liquid crystal pattern drive independently, preparing the marginal voltage of signal distinction, and measuring pulse width change and signal intensity that arbitrary positions can be recognized. Thus, the liquid crystal display panel showed that the characteristic ideal as a high-speed precise position sensing device could be read in a pickup. In these results, arrangement of a liquid crystal numerator changes to a drive pulse, and it is thought that the Idei light beam is optically adjusted by a steady refractive index being distributed. As factors other than a drive pulse condition, each window of 30 micrometer of the liquid crystal panel used this time is considered to be in the liquid crystal arrangement according to the electric field produced in the state of sharing a confrontation electrode-plate side.

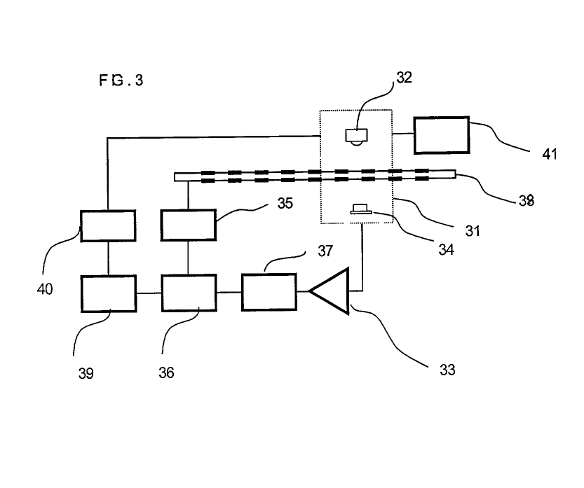

FIG. 3 shows the example of application to the absolute type servomechanism of the liquid crystal precise position sensing device which used the liquid crystal electrooptics effect. 31 in FIG. 3 is a measuring instrument unit, and this measurement length unit 31 includes light emitting diode 32 and PD 34, which have been arranged at the both sides of the liquid crystal display panel 38 and its liquid crystal display panel 38. Moreover, the measurement length unit 31 moves in connection with a drive of a motor 41.

By the spacer, the liquid crystal display panel 38 makes a pair of glass boards counter like FIG. 1, it holds an interval (for example, 5 micrometers), encloses liquid crystal, is constituted, carries out the vacuum evaporation of the ITO film to a glass board, and forms the liquid crystal drive electrode plate. A liquid crystal drive electrode plate is driven with the liquid crystal drive driver 35, and the liquid crystal drive driver 35 is controlled by CPU 36. A 30 micrometer pattern is arranged on the liquid crystal display panel 38, as for each position, the address is added to each, and the address is memorized by CPU 36.

The amplifier 33 amplifies the signal of PD 34, the position control unit 37 memorizes a starting position, the control unit 39 controls a motor 41, and 40 are servo drivers which drive a motor again.

With the equipment of FIG. 3, a position can be absolutely recognized by changing a pattern within a precise-position-sensing-device unit arbitrarily by liquid crystal drive. Absolutely, by position detection, the liquid crystal drive driver 35 is made to drive with the signal from CPU 36 first, and the liquid crystal display panel 38 is driven by the predetermined pattern. The discernment from other lattices is possible by making the position control unit 37 memorize the starting point, and driving the liquid crystal pattern of a required address after that. By it, position detection can be performed absolutely, without stamping a complicated absolute pattern. Moreover, when a power supply is again switched on by memorizing the starting point, the subject can be moved from the same position by liquid crystal drive. The configuration of FIG. 3 reduces burdens of signal processing of software, a question and starting time can be shortened at the time of maintenance, and high-speed movement can be carried out with very simple and highly efficient absolute encoder.

Although the precise position sensing device was explained as mentioned above, if control of a refractive index is used, the depth of a subject and the application to the precision detection will also be considered. Therefore, the “precise position sensing device” of this invention is applicable generally. Moreover, it may become the highly efficient substitution technology of high-speed optical disc production/inspection equipment or the pickup coil of an optical disk drive in which this invention was applied in the future. Moreover, component engineering, such as the measurement equipment of the very precise surface after chemistry machine polish and a high sensitivity optical microscope, are also possible. Moreover, it becomes technology useful for the high speed and the precision robot for semiconductor manufacture/inspection equipment, gene-diagnosis equipment and operation support equipment, and other fields that need such an actuator.

In this invention, superior performance to conventional magnetism and optical system is obtained by applying the liquid crystal electrooptics effect to the move position detection sensor of a servo drive for example. Furthermore, in this invention, as mentioned above, point detection is attained from the difference in amplitude and the improvement in SN is seen.

What is claimed is:

1. A position sensing device which comprises an optical modulator comprising two or more pixels, a drive part which applying a voltage to the optical modulator, a light source which irradiates light on the optical modulator, and a photodetector which detects the transmitted/scattered light of the light irradiated to the optical modulator, wherein the position sensing device has a control means to change a drive voltage applied to the drive part thereby controlling the height and/or the width of waveform of a signal.

2. The position sensing device as claimed in claim 1 in which the control means of the drive part controls the voltage of every pixel.

3. The position sensing device as claimed in claim 1 in which the optical modulator is a liquid crystal display panel, an electroluminescence (EL) device, an electronic paper or an electric-field drive coloring matter.

4. The position sensing device as claimed in claim 1 in which the liquid crystal display panel is a polymer materials selected from a double refraction type liquid crystal element, a transmission/scattering type liquid crystal element, a TN (twisted nematic) liquid crystal, an STN (super TN) liquid crystal, a ferroelectric liquid crystal element, an anti-ferroelectric liquid crystal, a polymer dispersed liquid crystal and a electroconductive material, a coloring material, a photonic crystal, or a non-line type material.

5. The position sensing device as claimed in claim 1 in which the floodlight is a light emitting diode, a laser, a lamp, or an EL (electro luminescence) device.

6. The position sensing device as claimed in claim 1 in which the photodetector is a photo-diode, a solid photodetecting sensor, a pyroelectric sensor or a thermopile.

7. Equipment which comes to have a move means to move a subject-ed to the position memorized and displayed in the precise position sensing device of claim 1 publication, the memory part which memorizes the position of the pixel of a precise position sensing device of operation, and this memory part.
